(19) United States
(12) Patent Application Publication
(10) Pub. No.: US 2015/0286508 A1
(43) Pub. Date: Oct. 8, 2015

(54) TRANSPARENTLY ROUTING JOB SUBMISSIONS BETWEEN DISPARATE ENVIRONMENTS

(71) Applicants: Jason A. STOWE, (US); Andrew KACZOREK, (US)

(72) Inventors: Jason A. Stowe, Greenwich, CT (US); Andrew Kaczorek, Carmel, IN (US)

(21) Appl. No.: 14/441,860

(22) PCT Filed: Nov. 26, 2013
(86) PCT No.: PCT/US13/72094

§ 371 Date: May 11, 2015

Related U.S. Application Data
(60) Provisional application No. 61/729,930, filed on Nov. 26, 2012.

(51) Int. Cl. G06F 9/50; G06F 9/48

(52) U.S. Cl. CPC G06F 9/5083; G06F 9/4887

(57) ABSTRACT

Exemplary embodiments of the invention include a method, apparatus and computer-readable medium for directing workload. The method includes receiving, by a processor, a workload for routing. The method further includes routing, by the processor, the workload, in response to determining where to route the workload based on continuously obtained real time performance and use data of a local computing cluster and an external computing cluster.

### BACKGROUND OF THE INVENTION

The present invention relates to high performance computing or big data processing systems, and to a method and system for automatically directing load away from busy distributed computing environments to idle environments and/or environments that are dynamically scalable.

Job scheduling environments enable the distribution of heterogeneous compute workloads across large compute environments. Compute environments within large enterprises tend to have the following characteristics:

Static size

Typically built out of physical machines

Largely homogeneous configuration

Heavily connected within the same cluster

Loosely connected with other regional clusters

Poorly connected to clusters in other geographic locations

Shared storage space typically not accessible between clusters

It is common to see hot spots where one cluster is busy and another is idle

As a result of variations in regional cluster size and regional workload demand, it is attractive to run jobs in other regions or geographic locations. However, since the workloads tend to be tightly coupled by network and storage constraints, it is difficult to build a functional workload that spans resources across these zones of high performance compute, networking, and storage resources.

### SUMMARY OF THE INVENTION

Exemplary embodiments of the present invention provide a system and method for any developer of high performance compute or “BigData” or “map-reduce” applications to make use of compute resources across an internal enterprise and/or multiple infrastructure-as-a-service (laaS) cloud environments, seamlessly. This is done by treating each individual cluster of computers, internal or external to the closed enterprise network, as regions of computational power with well-known performance characteristics surrounded by a zone of performance and reliability uncertainty. This system transfers the data and migrates the workload to remote clusters as if it existed and was submitted locally. For batch-type high performance jobs or the “map” portions of map-reduce jobs, which are equivalent for the purpose of this invention, the system moves the data and runs the separable partitions of the job in different computing environments, transferring the results back upon completion. In all places below where a portion of a batch type submitted workload is mentioned, the map portions of a map-reduce type submitted workload are equivalent. The decision making and execution of this workflow is implemented as a complete transparent process to the developer and application. The complexities of the data and job migration are not exposed to the developer or application. The developer need only make their application function in a single region and the invention automatically handles the complexities of migrating it to other regions.

The incumbent approach places compute geographically separated compute resources in the same scheduling environment and treats local and remote environments as equivalent. Two factors in the incumbent approach contribute to make the invention a superior solution for the problem. Factor one: operations across questionable WAN links that execute under the assumption of low latency and high bandwidth will consistently fail. Factor two: performance characteristics of global shared storage devices are typically so slow that they result in the perception of failure due to lack of rapid progress on any job in the workload. By avoiding both of these pitfalls, the invention ensures jobs can flow between environments more readily, and the execution of these jobs can proceed with the speed and reliability that the developer would expect when running on an internal cluster located in one region. The only additional costs paid in the scenario where the invention is used is the migration of data from the local to the remote cluster to support the job execution along with the transfer of result data back to the origination region after the computation has completed at the remote region.

Exemplary embodiments of the invention continuously gather detailed performance and use data from the clusters, and uses this data to make decisions related to job routing based on parameters such as:
The desire of the user or automated workload to direct the jobs to an internal environment based on security, performance, and regulatory compliance considerations;
Tolerance of the cost of running in an external, dynamic computing environment such as Amazon Web Services (AWS);
The existence of already synchronized portions or partitions of the data set required for a computation in a remote cluster;
Current utilization of all compute resources across the entire computing landscape;
Bandwidth available between clusters for data transfer, possibly combined with information about the amount of data that would need to be transferred there and back.

The matchmaking algorithm used to determine the eventual compute job routing is configurable to account for a variety of dynamic properties. Exemplary embodiments of the invention perform meta-scheduling for workloads by applying all the knowledge it has about the jobs being submitted and the potential clusters that could run the jobs and routing jobs to the appropriate regions automatically, without application, developer or end user intervention. The job meta-scheduling decision happens at submit time, or periodically thereafter, and upon consideration immediately routes the jobs out to schedulers that then have the responsibility for running the work on execute machines in specific regions, either internal or external, static or dynamic.

Exemplary embodiments of the invention allow for clusters and jobs scheduled in to them, to run completely independent of each other, imparting much greater stability as the need for constant, low-latency communication is not required to maintain a functional environment. Exemplary embodiments of the invention also allow for these clusters to function entirely outside of the scope of this architecture, providing for a mix of completely local workloads and jobs that flow in and out from other clusters via the Inventions meta-scheduling algorithm. This allows of legacy interoperability and flexibility when it comes to security: in cases where it is not desirable for jobs to be scheduled to run remote to their point of submission by the Invention, the end user can simply submit the jobs as the normally would to a local region. The Invention also promotes high use rates among widely distributed pools of computational resources, with more workloads submitted through its meta-scheduling algorithm resulting in greater overall utilization.

### BRIEF DESCRIPTION OF THE DRAWINGS

FIG. 1 is a block diagram which shows a process of job submission by an end user or a job submission portal such as CycleServer.

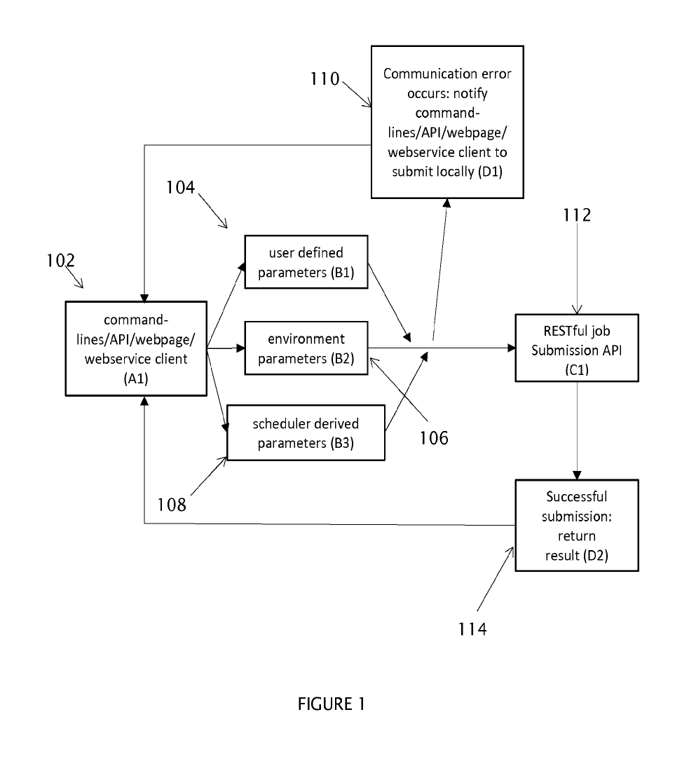

FIG. 2 is a block diagram which shows the routing engine of

SubmitOnce and the variables that can drive the decision.

FIG. 3 is a block diagram which shows the workflow of a remote job submission including data transfer and scheduler interaction.

FIG. 4 is a block diagram that shows the process of backfilling work onto a partially idle internal cluster when submitting to a remote cluster.

FIG. 5 is a flowchart showing SubmitOnce workload routing.

FIG. 6 is a flowchart showing SubmitOnce application workload routing architecture

### DETAILED DESCRIPTION

An exemplary embodiment of a process and system according to the invention are described below. It should be noted, however, that the embodiments below in no way restrict this disclosure. The embodiments described below are merely non-limiting examples for performing the invention herein.

Exemplary embodiments provide a system for submitting workload within the cloud that precisely mimics the behavior of scheduler-based job submission. Using the knowledge of the operation of the job scheduler, the system pulls as much metadata as possible about the workload being submitted.

Another exemplary embodiment provides for a job routing mechanism coupled with a scheduler monitoring solution that can account for a flexible number of environment parameters to make an intelligent decision about job routing. Exemplary embodiments allow the framework to use automated remote access to perform seamless data transfer, remote command execution, and job monitoring once the job routing decision is made.

Exemplary embodiments provide an architecture by which a set of jobs can run on multiple heterogeneous environments, using different schedulers or map-reduce or “BigData” frameworks in different environments, and transparently deposit the results in a consolidated area when complete. Exemplary embodiments also include a system for submitting workload within a cloud computing environment, wherein the system precisely mimics the behavior of a scheduler-based job submission by using the knowledge of the operation of the job scheduler, wherein the system pulls at least a portion of the available metadata corresponding to the submitted workload.

Exemplary embodiments of this invention provide for job routing mechanism coupled with a scheduler monitoring solution that can account for a flexible number of environment parameters to make a real time decision about job routing, including the use of periodic evaluation of the placement of some or all submissions, in multiple cluster environments. Yet another exemplary embodiment includes the framework to use automated remote access to perform seamless data transfer, remote command execution, and job monitoring once a job routing decision is made. A further exemplary embodiment includes the architecture by which a set of jobs can run on multiple heterogeneous environments and transparently deposit the results in a consolidated area upon job completion. An exemplary embodiment includes a method for directing a workload between distributed computing environments. The method includes continuously obtaining performance and use data from each of a plurality of computer clusters, a first subset of the plurality of computer clusters being in a first region and a second subset of the plurality of computer clusters being in a second region, each region having known performance characteristics, zone of performance and zone of reliability. The method further includes receiving a job for routing to a distributed computing environment. The method further includes routing the job to a given computer cluster in response to the obtained performance and use data, and the region encompassing the given computer cluster.

A further exemplary embodiment includes a method for directing a workload between distributed computing environments. The method includes identifying a finish by deadline and a batch/non-batch type associated with an electronically submitted workload. The method further includes processing the submitted workload by at least one of (i) routing the submitted workload to a local computer cluster in response to the local computer cluster having sufficient capacity to complete the submitted by the finish by deadline; (ii) routing a first portion of a batch type submitted workload, or equivalently the portions of map parts of a map-reduce type submitted workload, to an available capacity of the local computer cluster, and routing a second portion of the batch type submitted workload, or equivalently the second portions of map parts of a map-reduce type submitted workload, to at least one remote computer cluster; and (iii) routing a non-batch type submitted workload having a finish by deadline longer than a completion capacity of the local computer cluster to the remote computer cluster. For clarity, ‘map-reduce’ workloads are a batch type workload as are a map-reduce workload's constituent parts: the map portions and individual reduce jobs. Similarly, so-called ‘embarrassingly’ or ‘pleasantly’ parallel workloads, i.e. any workload composed of many independent calculations, even if each individual is strictly parallel, is a batch type workload.

Another exemplary embodiment includes a method for directing a workload between distributed computing environments. The method includes receiving a workload submission at an application workload router. The method further includes routing the workload submission by at least one of the steps of (i) routing a first portion of the workload submission, or equivalently the portions of map parts of a map-reduce type submitted workload, to a local computer cluster, the first portion of the workload submission, or equivalently the second portions of map parts of a map-reduce type submitted workload, being within available completion parameters of the local computer cluster and routing a second portion of the workload submission to a remote (non-local) computer cluster and (ii) routing the workload submission to the remote computer cluster in the absence of the local computer cluster.

This exemplary method can further include automatically modifying workflow steps to include outgoing and then incoming data transfer for data affiliated with a workload submission routed to one or more remote (non-local) computer clusters.

The job submission command-lines/API/webpage/webservice gathers at block 106 environment information, at block 108 derived variables pulled from a dry run of the routing/submission and at block 104 user input metadata. In the case where the server environment located at block 112 is unavailable or takes too long to respond, the job submission executable will always execute the submission locally at block 110. This way, job submission always occurs within a predefined time interval.

In the case where a task runs on multiple clusters, the output will be differentiated through the workflow using a prefix designated by the cluster name as defined in the system. The output of the job submission should be identical to the output produced by the native scheduler commands. This way, users, workloads, or APIs that leverage this system can interoperate transparently with this system. This output is returned by the server environment during typical execution located at block 114

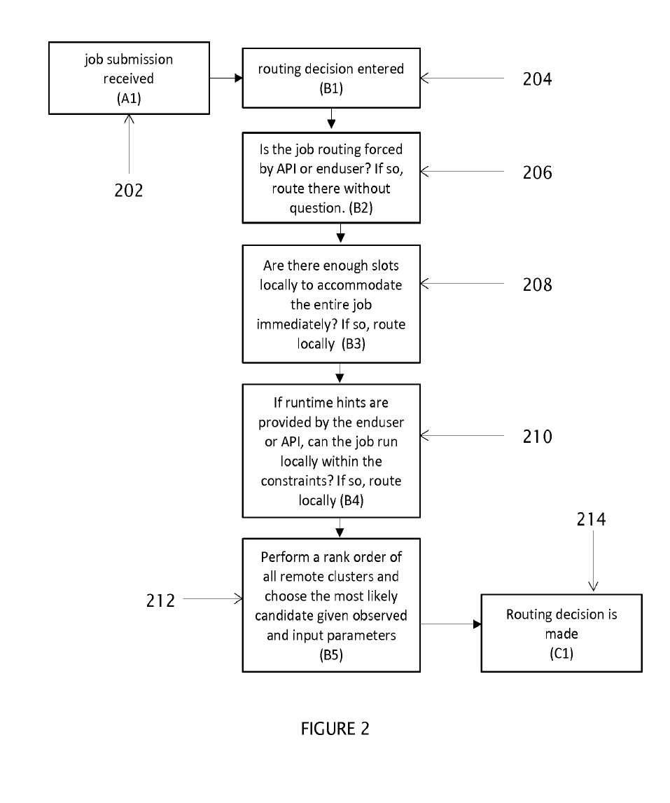

FIG. 2 shows another exemplary embodiment of the present invention. Shown in FIG. 2 is a block diagram depicting the routing engine of SubmitOnce and the variables that can drive the decision procedure.

The processes and components in this system in FIG. 2 include GUI dashboards within a server architecture that can be used to configure, manage, and monitor the job routing and submission behaviors received at block 202. It should also include default submission configurations that can be used by administrators to configure the system to conform to their specific policies and expectations. Block 204 can incorporate metadata that can be defined for the scheduling environments such as, but not limited to, available shared storage space, advertised applications, current capacity, oversubscription thresholds and dynamic execute node capabilities. This metadata can be input during configuration and/or derived in realtime by the monitoring environment as shown in block 212. Preference may be given to routing the job locally if it is most expedient as shown in blocks 206, 208, and 210. The full matchmaking routine is only entered if local routing is not immediately apparent as at block 212. The routing decision is ultimately used to process the actual submission, no matter what cluster unit is chosen located at block 214.

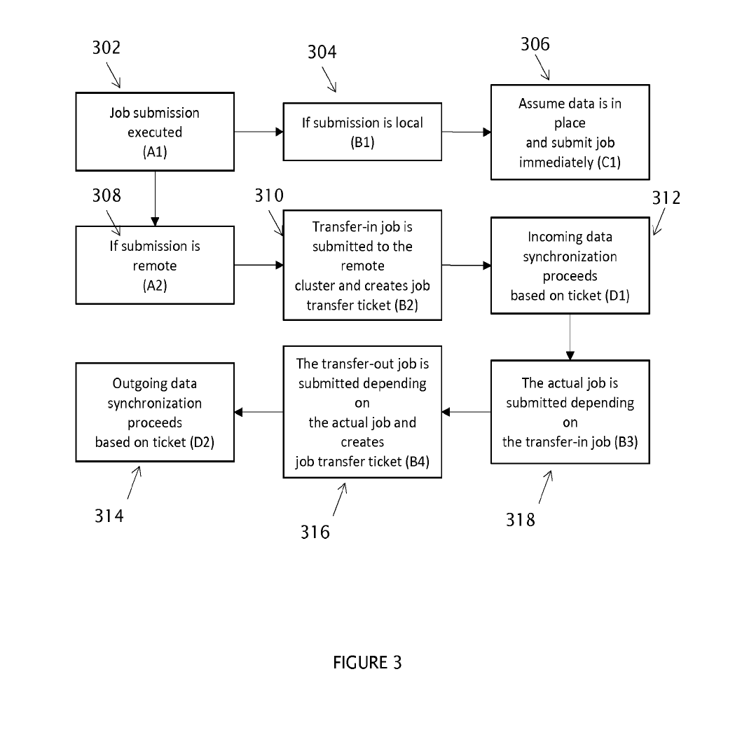

FIG. 3 presents another exemplary embodiment of the invention herein. FIG. 3 illustrates a block diagram depicting the workflow of a remote job submission including data transfer and scheduler interaction.

The processes and components in this embodiment in FIG. 3 includes a hub-and-spoke design for a central server to communicate with one or more cluster units located in block 302. The key decision during the submission is whether or not the routing is local or remote, because this dictates the requirement to move data to either block 304 or block 308. It should be noted that cluster units can represent both internal clusters of machines and external clusters of machines, with statically allocated or dynamically allocated lists of computational resources. FIG. 3 requires a ticket-based data transfer mechanism that can provide both internal-initiated and external-initiated data transfers on either a scheduled or on-demand basis as used in blocks (310, 316) and (312, 314). This process also needs secure, reliable communication between the central server and the remote nodes for command execution for the steps located at blocks (306, 318). There should also be proper error handling of any potential failure before, during, or after a committed job submission. If any errors are encountered, the system should submit locally as a failsafe as in block 306.

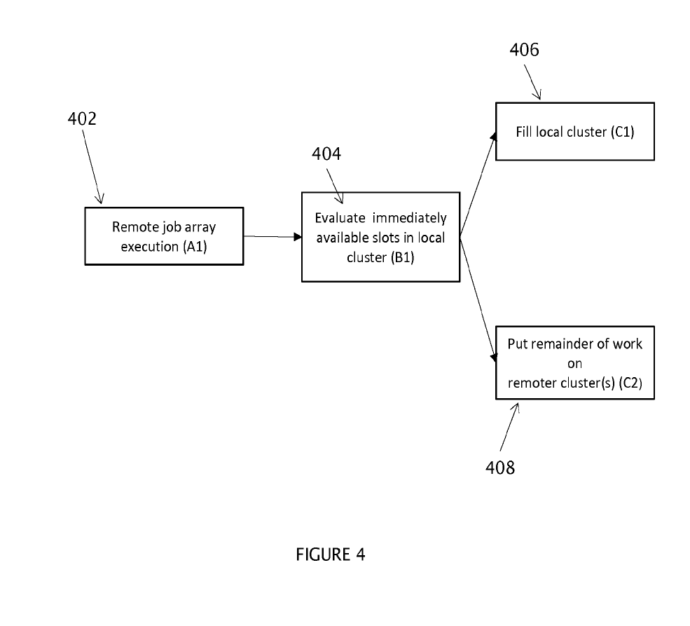

FIG. 4 presents yet another exemplary embodiment of the present invention. FIG. 4 depicts a block diagram of the process of backfilling work onto a partially idle internal cluster when submitting to a remote cluster.

The processes and components in this exemplary embodiment begin when a job submission is committed to a particular cluster unit, there is an opportunity for further load balancing. Although the bulk of the workload is designated for the remote cluster unit, a subset of the workload may be carved off to run on local resources that are immediately available, decreasing the overall runtime as in block 402. This branch of behavior is only taken if the following is true: (1) the submission is not a tightly coupled parallel job (2) the submission is a job array (3) the ability to split task arrays is enabled within the system. The system counts the number of available execution slots, counts the running jobs, and calculates the available slots at block 404. The job array is split such that the local cluster is filled first at block 406 and the remainder of jobs is submitted to selected remote cluster(s) at block 408. These two or more submissions created for block 406 and block 408 are processed, and the workflow proceeds as described above.

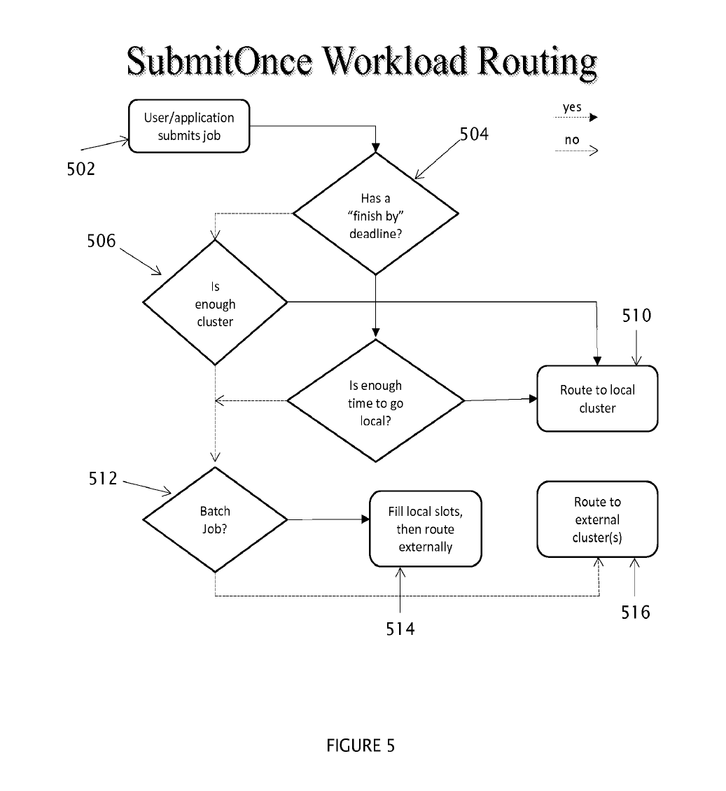

FIG. 5 presents another exemplary embodiment of the present invention. FIG. 5 presents a SubmitOnce Workflow Routing flowchart. The process begins with the user/application submitting a job at block 502. The process continues with determining the job has a “finish by” deadline at block 504. If there is no “finish by” deadline then the process determines whether there is enough cluster space at block 506. If yes, then the process routes to a local cluster at block 510. If no, then it is determined if this is a batch job at block 512. If yes, then the process fills local slots, then route externally at block 514. If no then the process simply routes externally at block 516. However, if there is a “finish by” deadline then the process determines whether there is enough time to go local at block 508. If yes, then it is routed to a local cluster at block 510. If no, then it is determined whether this is a batch job at block 512 and the process continues from there as before.

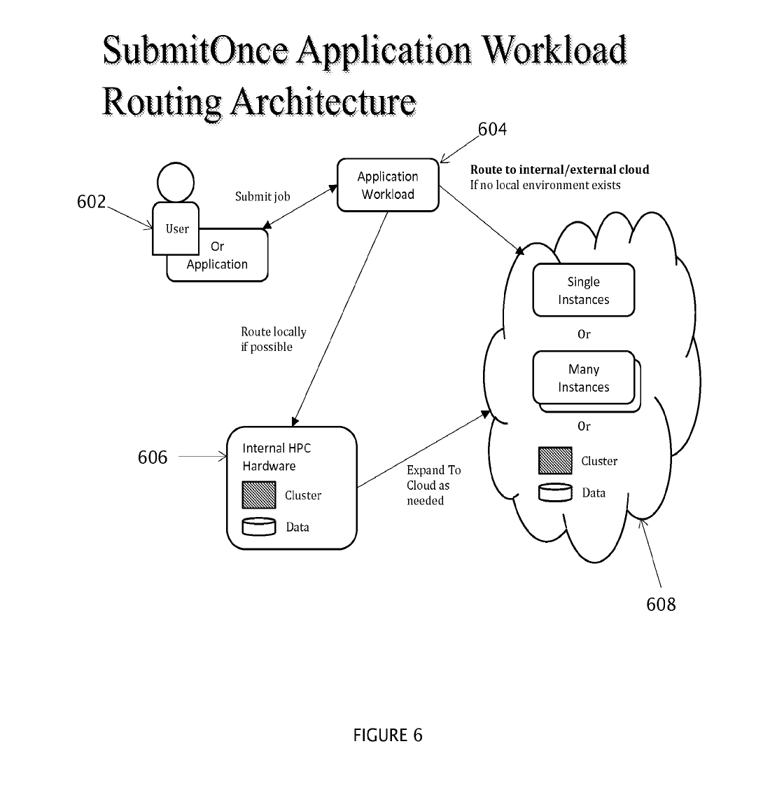

FIG. 6 presents an exemplary embodiment of the present invention. FIG. 6 illustrates a SubmitOnce application workload routing architecture. The routing architecture begins at block 602 with a user or application submitting a job. At block 604 the job is received by an application workload router. If there are no local environmental clusters then the job is routed to an internal/external cloud at block 608. If it is possible to route locally then the job is sent to block 606. However, if needed, the job can expand from the local clusters to the cloud at block 608 if needed.

An exemplary method for practicing the teachings of this invention includes a method for directing workload. The method comprises receiving, by a processor, a workload for routing; and routing, by the processor, the workload, in response to determining where to route the workload based on continuously obtained real time performance and use data of a local computing cluster and an external computing cluster. The method further includes identifying a finish by deadline and a batch/non-batch type associated with the workload received.

The exemplary method further includes wherein the routing comprises routing to the local computing cluster in response to the continuously obtained real time performance and use data of the local computing cluster having sufficient capacity to complete the workload by the finish by deadline. The method also includes wherein the routing comprises a first portion of a batch type submitted workload to the local computing cluster, or equivalently the map portions of a map-reduce type submitted workload, and routing a second portion of the batch type workload, or equivalently the second portions of the maps in a map-reduce type submitted workload, to at least one external computing cluster.

The exemplary method can also include wherein the routing further comprises a non-batch type workload with a finish by deadline longer than a completion capacity of the local computing cluster and routing the non-batch type workload to the external computing workload. The method can further comprise modifying, by the processor, where the first and the second portion of the batch type submitted workload is routed.

This exemplary method may also be a result of execution of a computer program stored in a non-transitory computer-readable medium, such as non-transitory computer-readable memory, and a specific manner in which components of an electronic device are configured to cause that electronic device to operate. The exemplary method may also be performed by an apparatus including one memory with a computer program and one processor, where the memory with the computer program is configured with the processor to cause the apparatus to perform the exemplary method.

In general various exemplary embodiments of this invention can be performed by various electronic devices which include a processor and memory such as a computer.

Users of large scale computing environments need the ability to take advantage of many separate compute environments without fully understanding the underlying scheduler, server, and network configuration.

A solution of the present disclosure includes providing the end-users with an interface that allows for typical job submissions while automating job flow to local and external clusters. This increases the capabilities of the end-user without burdening them with complicated configuration and processes. The automation within the application workload router hides excess complexity from the end-user while augmenting capabilities that would typically be constrained to a single independent cluster.

Once this automated job routing environment is completely configured, the end-user needs a way to fully describe his or her workload for proper routing. Most of this description is achieved using the scheduling layer. Other than reliable execution, the most important parameter to an end-user is the elapsed time for an entire workload. The disclosure provides the solution of a job routing environment that allows the end-user to provide two additional important pieces of information. One is the average runtime of an individual task. Another is the overall desired runtime of the workload. This information is considered along with parameters already known, such as the number of tasks, dynamic VM node spin-up time, data transfer time, and whether or not this is a purely batch workload. The end result is that jobs can be split across multiple clusters, maximizing internal cluster usage while still fulfilling the request.

What is claimed is:

1. A method for directing workload, the method comprising:
(a) receiving, by a processor, a workload for routing; and
(b) routing, by the processor, the workload, in response to determining where to route the workload based on continuously obtained real time performance and use data of a local computing cluster and an external computing cluster.

2. The method according to claim 1, the method further comprising identifying a finish by deadline and a batch/non-batch type associated with the workload received.

3. The method according to claim 2, wherein the routing comprises routing to the local computing cluster in response to the continuously obtained real time performance and use data of the local computing cluster having sufficient capacity to complete the workload by the finish by deadline.

4. The method according to claim 2, wherein the routing comprises a first portion of a batch type submitted workload to the local computing cluster and routing a second portion of the batch type workload to at least one external computing cluster.

5. The method according to claim 2, wherein the routing further comprises a non-batch type workload with a finish by deadline longer than a completion capacity of the local computing cluster and routing the non-batch type workload to the external computing workload.

6. The method according to claim 4, the method further comprising modifying, by the processor, where the first and the second portion of the batch type submitted workload is routed.

7. An apparatus comprising:
(a) at least one processor and at least one memory storing a computer program, in which the at least one memory with the computer program is configured with the at least one processor to cause the apparatus to at least:
(b) receive a workload for routing; and
(c) route the workload, in response to determining where to route the workload based on continuously obtained real time performance and use data of a local computing cluster and an external computing cluster.

8. The apparatus according to claim 7, in which the at least one memory with the computer program is configured with the at least one processor to cause the apparatus to identify a finish by deadline and a batch/non-batch type associated with the workload received.

9. The apparatus according to claim 8, wherein the routing comprises routing to the local computing cluster in response to the continuously obtained real time performance and use data of the local computing cluster having sufficient capacity to complete the workload by the finish by deadline.

10. The apparatus according to claim 8, wherein the routing comprises a first portion of a batch type submitted workload to the local computing cluster and routing a second portion of the batch type workload to at least one external computing cluster.

11. The apparatus according to claim 8, wherein the routing further comprises a non-batch type workload with a finish by deadline longer than a completion capacity of the local computing cluster and routing the non-batch type workload to the external computing workload.

12. The apparatus according to claim 10, in which the at least one memory with the computer program is configured with the at least one processor to cause the apparatus to modify where the first and the second portion of the batch type submitted workload is routed.

13. A non-transitory computer-readable medium storing a computer program executable by at least one processor, wherein the computer program when executed by the at least one processor causes the processor to at least:
(a) receive a workload for routing; and
(b) route the workload, in response to determining where to route the workload based on continuously obtained real time performance and use data of a local computing cluster and an external computing cluster.

14. The non-transitory computer-readable medium according to claim 13, wherein the computer program further causes the processor to identify a finish by deadline and a batch/non-batch type associated with the workload received.

15. The non-transitory computer-readable medium according to claim 14, wherein the routing comprises routing to the local computing cluster in response to the continuously obtained real time performance and use data of the local computing cluster having sufficient capacity to complete the workload by the finish by deadline.

16. The non-transitory computer-readable medium according to claim 14, wherein the routing comprises a first portion of a batch type submitted workload to the local computing cluster and routing a second portion of the batch type workload to at least one external computing cluster.

17. The non-transitory computer-readable medium according to claim 14, wherein the routing further comprises a non-batch type workload with a finish by deadline longer than a completion capacity of the local computing cluster and routing the non-batch type workload to the external computing workload.

18. The non-transitory computer-readable medium according to claim 16, in which the computer program is configured to cause the processor to modify where the first and the second portion of the batch type submitted workload is routed.
